(19) United States
(12) Patent Application Publication
(10) Pub. No.: US 2024/0029376 A1
(43) Pub. Date: Jan. 25, 2024

(54) SPATIAL FOVEATED STREAMING -MEDIA DISTRIBUTION FOR EXTENDED REALITY DEVICES

(71) Applicant: YouVue Corporation, Healdsburg, CA (US)

(72) Inventor: JOSEPH MIKHAIL, Healdsburg, CA (US)

(21) Appl. No.: 18/042,436

(22) PCT Filed: Aug. 23, 2021
(86) PCT No.: PCT/US21/47189

§ 371 Date: Feb. 21, 2023

Related U.S. Application Data
(60) Provisional application No. 63/260,426, filed on Aug. 19, 2021.
(60) Provisional application No. 63/068,942, filed on Aug. 21, 2020.
(60) Provisional application No. 63/068,912, filed on Aug. 21, 2020.
(60) Provisional application No. 63/068,920, filed on Aug. 21, 2020.

(51) Int. Cl. G06T 19/20; G06T 19/00; G06F 3/01

(52) U.S. Cl. CPC G06T 19/20; G06T 19/006; G06F 3/013; G06T 2219/2012

(57) ABSTRACT

Systems and methods for implementing one or more extended reality media/content distribution systems are provided. More specifically, a three-dimensional model may be requested by a user. The request may be received by a server. The server can retrieve the model data and begin a rendering of the model. However, the render may not be complete. Rather, the client can complete the rendering of the model data, where high fidelity viewing may be possible with initial partial streaming, not contingent on full media download to start viewing. The split render system has the capability to dynamically switch between source data, server location, media components, and distribution algorithm(s) in real time to optimize viewer experience and minimize access time and motion latency. This split rendering reduces the bandwidth used to send the rendered data but also reduces the processing requirements on the client.

### CROSS-REFERENCE TO RELATED APPLICATIONS

This Application is being filed on Aug. 23, 2021 as a PCT Patent Application of, and claims priority the benefit of and priority to U.S. Provisional Patent Application No. 63/260,426, filed Aug. 19, 2021, U.S. Provisional Patent Application No. 62/068,942, filed Aug. 21, 2020, U.S. Provisional Patent Application No. 62/068,912, filed Aug. 21, 2020, and to U.S. Provisional Patent Application No. 62/068,920, filed Aug. 21, 2020, the disclosures of which are hereby incorporated by reference herein in their entirety for all that they teach and for all purposes.

### BACKGROUND

Media provided over digital platforms has evolved over years. Originally, music was downloaded for listening at user devices. Video then followed and was downloaded and presented to the user on their device. The next step in the evolution of entertainment is to provide interactive media. The interactive media is generally a form of three-dimensional model that can be interacted with by a user on their device. As the past evolutions of digital media has shown, each new generation of media introduces new media elements that must be synchronized in real-time and requires new media distribution innovations and/or technologies. Unlike the music and video downloaded previously, interactive media requires more bandwidth to allow for the communication of interactions with that media and to provide three-dimensional data not required for video or music. Thus, there is a need to improve the presentation of interactive media.

### BRIEF DESCRIPTION OF THE DRAWINGS

FIG. 1 depicts a system, in an environment, to supply three-dimensional (3D) model data/rendering in accordance with embodiments of the present disclosure.

FIG. 2A depicts a block diagram of an embodiment of a computing environment of an interactive media distribution system in accordance with embodiments of the present disclosure.

FIG. 2B depicts a hardware/software configuration for a server or cloud computing function and/or a client of a system that can distribute interactive media in accordance with embodiments of the present disclosure.

FIG. 2C depicts a computing environment that may function as a server, user computer, or other system provided and described herein, in accordance with embodiments of the present disclosure.

FIG. 2D depicts an example of a computer system upon which a server, computer, computing device, or other system or components may be deployed or executed in accordance with embodiments of the present disclosure.

FIG. 2E depicts another hardware/software configuration for a server or cloud computing function of a system that can distribute interactive media in accordance with embodiments of the present disclosure.

FIG. 3A depicts one or more data structures stored, retrieved, and/or communicated in the system that can distribute interactive media in accordance with embodiments of the present disclosure.

FIG. 3B depicts one or more data structures stored, retrieved, and/or communicated in the system that can distribute interactive media in accordance with embodiments of the present disclosure.

FIG. 4 is a signpost diagram depicted example communications in system that can distribute interactive media in accordance with embodiments of the present disclosure.

FIG. 5 depicts a first method for distributing interactive media in accordance with embodiments of the present disclosure.

FIG. 6 depicts a second method for distributing interactive media in accordance with embodiments of the present disclosure.

FIG. 7 depicts a third method for distributing interactive media in accordance with embodiments of the present disclosure.

FIG. 8 depicts a visual representation of foveation and the associated foveated streaming in accordance with embodiments of the present disclosure.

### DETAILED DESCRIPTION

Embodiments of the present disclosure will be described in connection with the included figures. In the figures, like numerals represent similar components or elements. The figures and the following description describe an interactive media distribution system and method for distributing the interactive media.

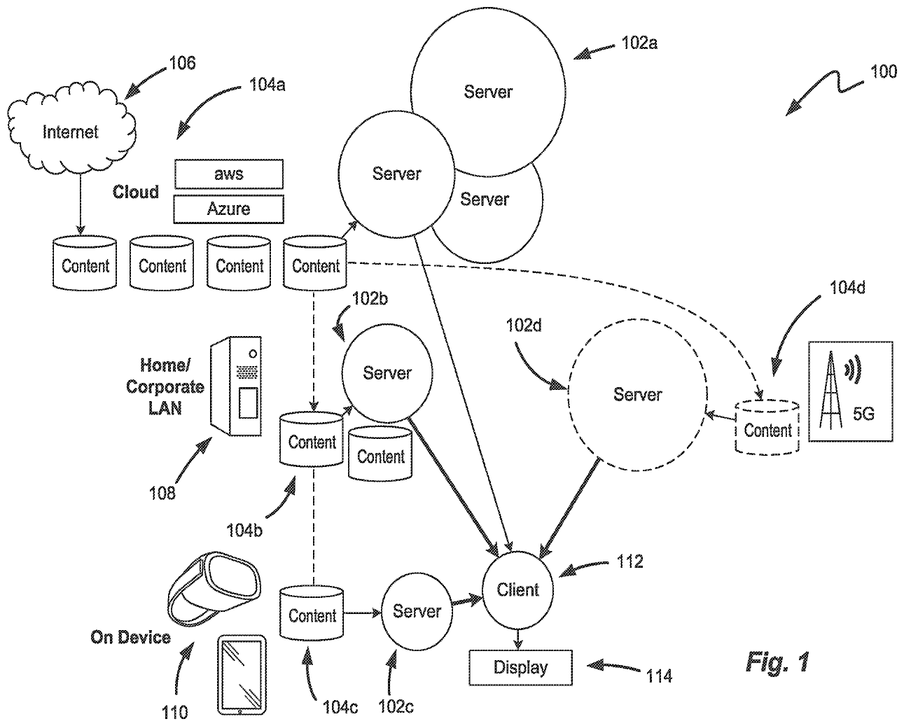

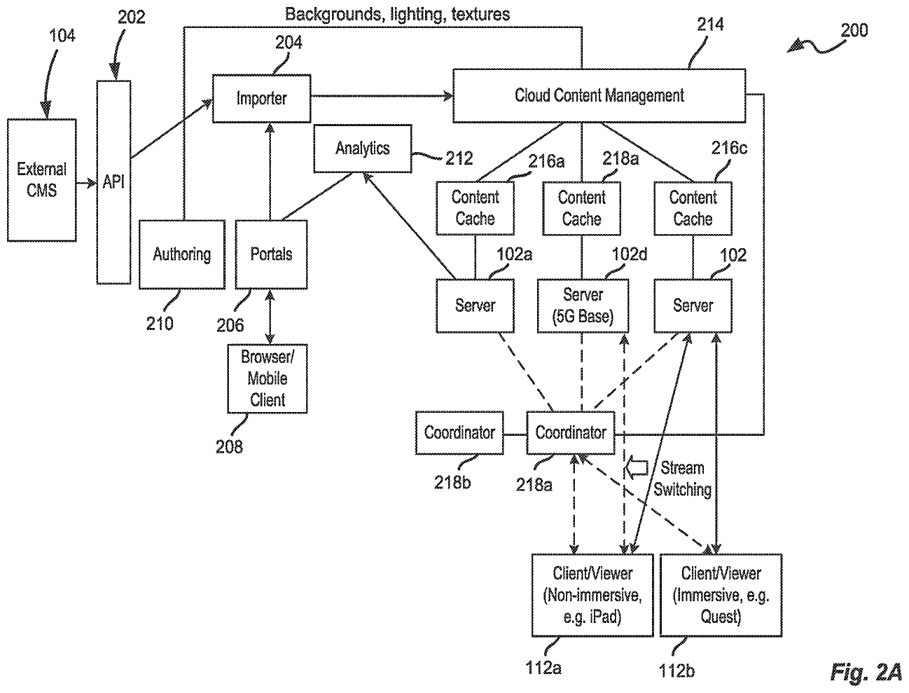

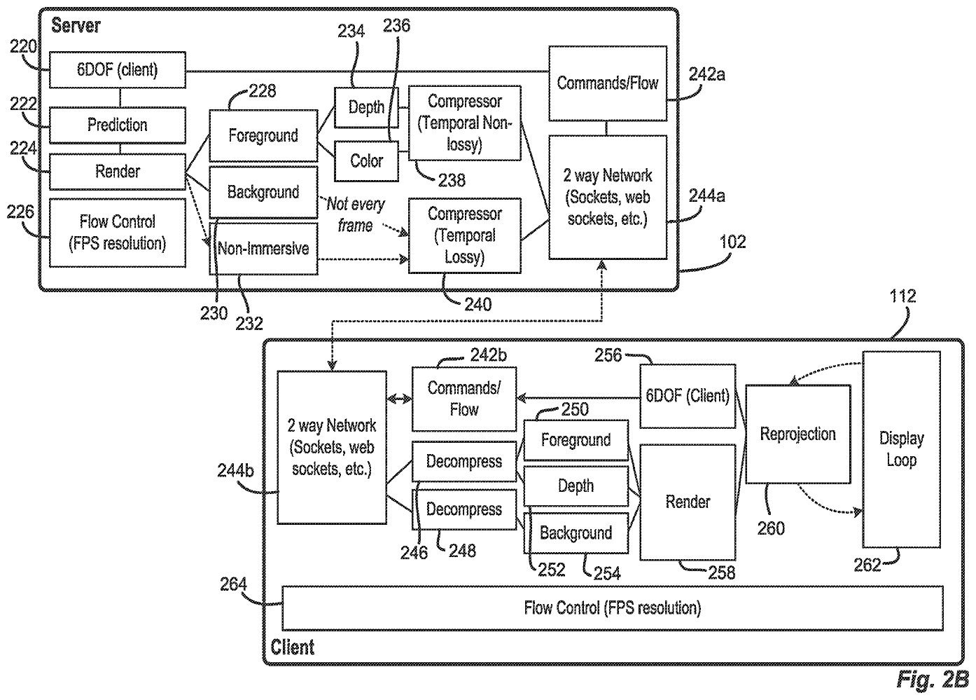

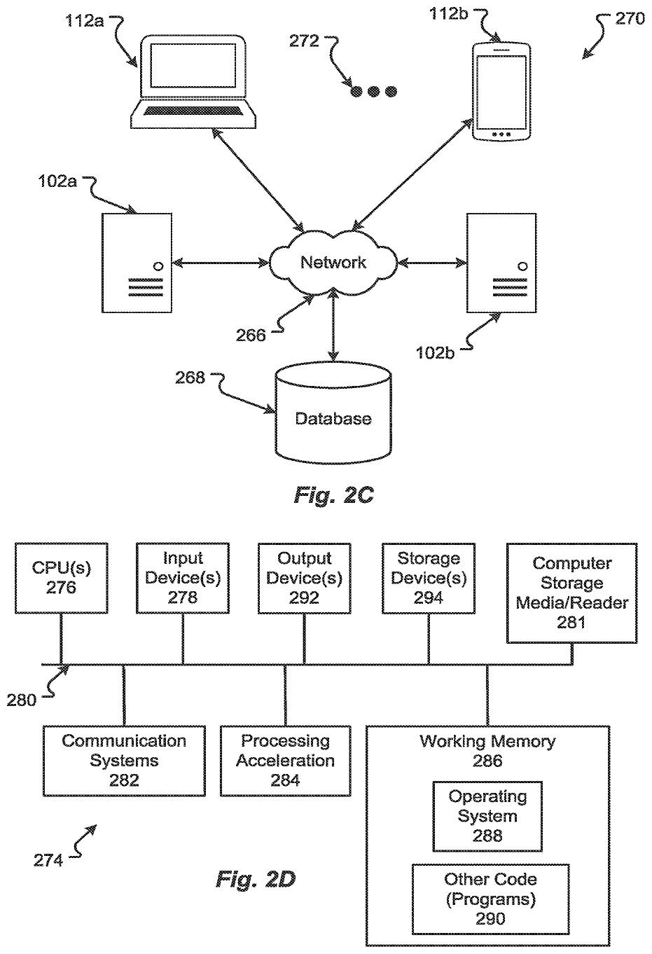

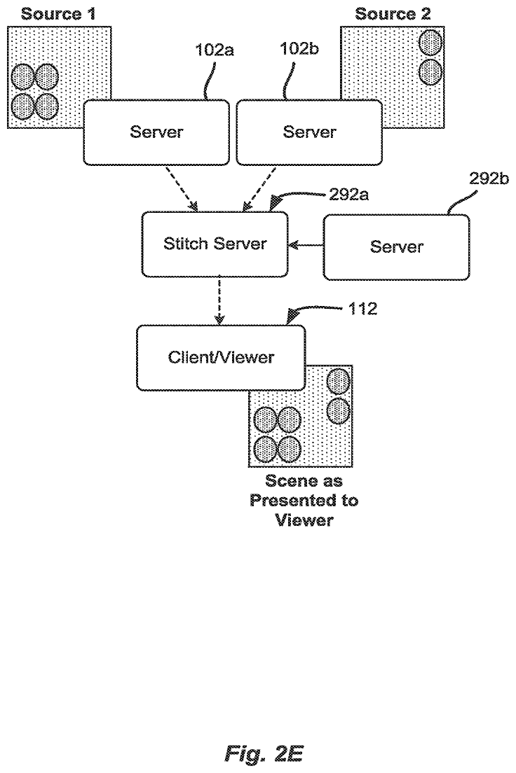

An example system 100 for distributing interactive media and/or providing an extended reality experience may be shown in FIG. 1. Extended reality (XR) can refer to any real-and-virtual combined environments and human-machine interactions generated by computer technology and wearables. XR can include representative forms of real-and-virtual combined environments, for example, augmented reality (AR), mixed reality (MR), virtual reality (VR), and the areas interpolated among them. The levels of virtuality range from partially sensory inputs to immersive virtuality, e.g., VR. The system 100 can include one or more servers 102A through 102E. The servers 102 can communicate and/or receive data and send data to one or more clients 112. The server 102 and the client 112 can be software, hardware, or a combination of software and hardware. The server 102 and the client may be computer systems, as described in conjunction with FIGS. 2A and 2E.

The server 102 may be associated with one or more types of systems or configurations that provide interactive media differently. For example, server 102a may be a cloud-based server at a server farm or some other type of distantly placed computing system 104a. The server 102a may receive content from one or more content data stores 104a, and those content data stores 104a may receive data through one or more providers through and Internet 106 or other type of network.

In other implementations, the server 102b may be associated with a Local Area Network (LAN) 108. The content databases 104b may be physically associated or disposed with the LAN 108. As such, the server 102b may obtain content locally from the LAN 108. In other implementations, the server 102c may be associated with the content data store 104c, which is provided with a client device 110. The client 112 may be a software instantiation that is executed on the device 110. Still in other situations or implementations, the server 102d may be associated with a cellular network 116 and content data stores 104d, stored thereon or therewith.

The client 112 may be hardware, software, and or hardware and/or software associated with the device 110 that can display the interactive media on a display device 114. The client 112 may receive the model data for rendering or final rendering of that content at the client 112 for display on the display device 114.

Implementations of one or more hardware and/or software components of the system 200, which may be implemented in the one or more servers 102 or clients 112 may be as shown in FIG. 2A. The system 200 can include an external Content Management System (CMS) 104, which may function to manage the content data stores. Thus, the CMS 104 can be a data management system that can store, retrieve, or communicate interactive media content to and from the server 102.

This content management system 104 may be in communication with an Application Programming Interface (API) 202. The API 202 may be executed at one of the servers 102 and can be operable to translate content from the CMS 104 into a format usable by the server 102. The API 202 may communicate the translated model information from the CMS 104 to an importer 204.

The importer 204 may retrieve the interactive media data from the CMS 104 for provision to the cloud content management system 214. The importer 204 can receive instructions to retrieve interactive content and provide that content to the CMS 214. The content management system 214 can provide the content to a server 102a, 102d, etc. The content may be at least partially rendered at the servers 102 before provision to a conductor 218 which then sends the rendered content to a client viewer, 112b. The model data may also be cached at a content cache data store 216a-216c. The content cache 216 provides for a storage system for the server 102 (the cache 216 can be in physical proximity to the server 102). The content cache 216 allows the server 102 to retrieve the content quickly rather than requesting content from the external CMS 104.

The coordinator 218a and/or coordinator 218b can receive the content from one or more servers 102 and stitch the content together for provision to the viewer on the client 112. The second coordinator 218b may be listening to coordinator 218a and provide a hot-swappable system to allow the coordination of content to continue even with failure of the coordinator 218a. The one or more clients 112a, 112b can receive the interactive content and can complete any final rendering or other operations on the content. Once the model is completely rendered, the client 112 may present the rendered content to the display 114.

In some implementations, the servers 102a-102c can communicate information to an analytics system 212. The analytics system 212 may determine information that improves the provision of rendered content to the client 112. For example, the analytics system 212 may determine latency or a delay in rendered frames of content being delivered from the servers 102 to the client 112. The analytics can also be provided to a portal 206 that allows for the provision of models into the importer 204 from a browser mobile client 208. The browser mobile client 208 can provide models directly to the importer 204. The content cloud management system 214 can also accept authored models through an authoring component 210. The authoring component 210 can allow for the direct creation of models into the system 200 rather than through an external CMS 104 or portal 206.

Implementations of software components for the media system may be as shown in FIG. 2B. These associated components may be electrically and/or communicatively coupled to one another via at least one bus or another interconnection. In some configurations, the one or more associated components may send and/or receive signals across a communication network to a separate entity, for example, server 102 and/or client 112. The computing systems 102/112 can include any hardware and/or software to conduct operations, as described herein, in accordance with embodiments of the present disclosure. The computing systems 102/112 may be as described in conjunction with FIGS. 2C and 2D.

A server 102 and a client 112 can share a communication link between network communication interfaces 244a-244b. The network communication links 244 can use any type of network, protocol, format, etc. For example, the communication interfaces 244 might communicate over a 5G cellular network, over a wide area network (WAN), over a LAN, over a wireless network (for example, a wireless LAN), over a near field communication link (for example, Bluetooth or a Wi-Fi connection), or over other types of communication links. The network interfaces 244 may be able to communicate over one or more different types of links based on the situation and configuration of the client device 112.

The communications interface 244 can also include a controller/microprocessor and a memory/storage/cache. The communications interface 244 can interact with the memory/storage/cache which may store information and operations necessary for configuring and transmitting or receiving the information described herein. The memory/storage/cache may also be used in connection with the execution of application programming or instructions by the controller/microprocessor, and for temporary or long-term storage of program instructions and/or data. As examples, the memory/storage/cache may comprise a computer-readable device, RANI, ROM, DRAM, SDRAM, and/or other storage device(s) and media.

The controller/microprocessor may comprise a general-purpose programmable processor or controller for executing application programming or instructions related to the communications interface 244. Furthermore, the controller/microprocessor can perform operations for configuring and transmitting/receiving information as described herein. The controller/microprocessor may include multiple processor cores, and/or implement multiple virtual processors. Optionally, the controller/microprocessor may include multiple physical processors. By way of example, the controller/microprocessor may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The communications interface 244 can further include a transmitter and receiver which can transmit and receive signals, respectively, to and from other devices, subsystems and/or other destinations using the one or more antennas and/or links/busses. Included in the communications interface 244 circuitry is the medium access control or MAC Circuitry. MAC circuitry provides for controlling access to the wireless medium. In an exemplary embodiment, the MAC circuitry may be arranged to contend for the wireless medium and configure frames or packets for communicating over the wired/wireless medium.

The communications interface 244 can also optionally contain a security module (not shown). This security module can contain information regarding but not limited to, security parameters required to connect the device to one or more other devices or other available network(s), and can include WEP or WPA/WPA-2 (optionally, AES and/or TKIP) security access keys, network keys, etc. The WEP security access key is a security password used by Wi-Fi networks. Knowledge of this code can enable a wireless device to exchange information with an access point and/or another device. The information exchange can occur through encoded messages with the WEP access code often being chosen by the network administrator. WPA is an added security standard that is also used in conjunction with network connectivity with stronger encryption than WEP.

In some embodiments, the communications interface 244 also includes a GPU, an accelerator, a Wi-Fi/BT/BLE PHY module and a Wi-Fi/BT/BLE MAC module and wireless transmitter and receiver. In some embodiments, the GPU may be a graphics processing unit, or visual processing unit, comprising at least one circuit and/or chip that manipulates and changes memory to accelerate the creation of images in a frame buffer for output to at least one display device. The GPU may include one or more of a display device connection port, printed circuit board (PCB), a GPU chip, a metal-oxide-semiconductor field-effect transistor (MOSFET), memory (e.g., single data rate random-access memory (SDRAM), double data rate random-access memory (DDR) RAM, etc., and/or combinations thereof), a secondary processing chip (e.g., handling video out capabilities, processing, and/or other functions in addition to the GPU chip, etc.), a capacitor, heatsink, temperature control or cooling fan, motherboard connection, shielding, and the like.

A six (6) Degree Of Freedom client (DOF) 256, at the client 112, can communicate orientation and/or position information through the communication interface 244 to a second DOF client 220 at the server 102. Sensors at the client 112 can generate the current orientation parameters for the client 112. The client DOF 256 can receive and determine the parameters to send to the server 102. For example, client DOF 256 may determine the head position, eye position and/or focus, pupil dilation, or other parameters associated with what the client is viewing at any time. These parameters indicated a direction of the stare or gaze to determine focus of the client in three-dimensional space. Other parameters may be determined. DOF data may be categorized in two general stages: a) Head/Device Positioning, using Simultaneous Localization and Mapping (SLAM) technology, which uses depth sensors to orient viewer positioning in a given space; and b) Eye-Tracking technology, which tracks exactly which point of a scene the viewer is focused on.

Further, the gaze and other parameters may be updated based on movement. In other implementations, the gaze and other parameters may be provided periodically, for example, every millisecond, every 100 milliseconds, once a second, etc. The parameters are received by the DOF client 220 at the server 102. This information is then provided to the prediction component 222. The prediction component 222 can predict possible movement from the client 112 parameters and thus determine a view to render based on where the user's gaze will be looking at some future point, for example, within 100 milliseconds. The prediction for the gaze orientation may then be provided to the render component 224.

The render component 224 can receive a model and render the different components of the model based on the gaze of the user. This gaze information allows for a decoupling between original rendering and client viewing, with full quality render being generated and available on the server, with the ability to simultaneously serve unique points of view per individual viewing experience. Thus, the render component 224 can determine the portions the model to render and what data to communicate to the client 112 based on the view of the user. A portion of the information from the DOF client 220 may enable a determination of the focus of the user. The focus of the gaze in a scene being viewed by the user can allow for foveated streaming. Foveated streaming may be an interactive content processing technique in which the image resolution, or amount of data sent, varies across a rendering of a 3D model according to one or more “fixation points” or focus. A fixation point indicates the highest resolution region of the image and corresponds to the center of the eyes' retinas. Thus, the render component 224 may only render in high quality or high resolution (e.g., use a higher number of pixels or polygons) in that part of the model which is associated with the fixation point of the user's gaze. In other implementations, the amount of model data or rendered data changes based on whether the data is associated with part of the fixation point or is outside the fixation point.

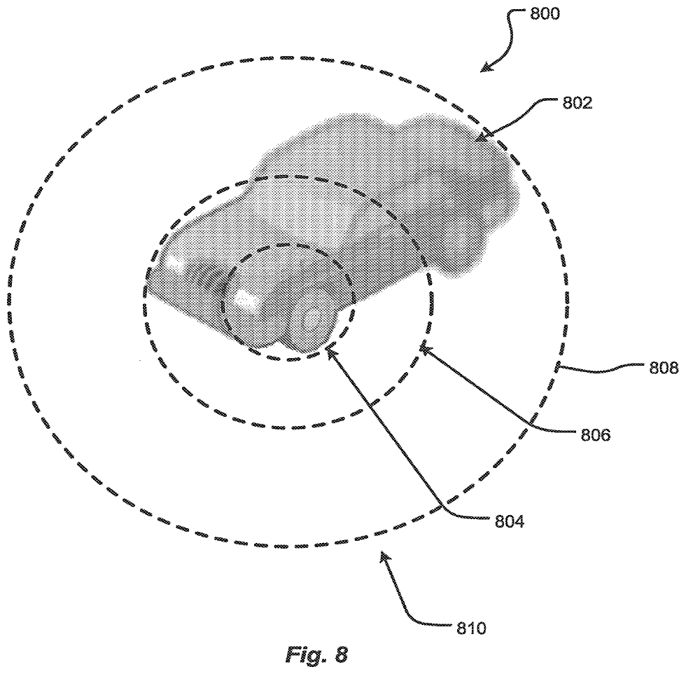

An example of foveation 800 may be as shown in FIG. 8. The focus of the gaze or the fixation point is the part of the model 802 in circle 804. Thus, the highest level of resolution should be presented for the model 802 in circle 804. The area between circle 804 and circle 806 may not be the focus and can be rendered at a lower resolution (as shown) or the data sent to the client for this area can be reduced. Similarly, the area between circle 806 and circle 808 may rendered at a lowest resolution (as shown) or the data sent to the client for this area can be reduced further. Finally, the area outside the viewing area, represented by circle 808 may not be presented at all. Thus, based on foveation, the server 102 can use less dense pixilation or polygon resolution as the models view extends from the focal point of the user's gaze. Using foveation in this manner reduces the bandwidth required to send the model data or the renderings from the server 102 to the client 112.

Other information from the flow control component 242 may be provided to the render component 224. The flow control component 242 can change the number of frames per second or the resolution of model based on network congestion or the ability of the client 112 to receive or process frames from the server 102. In this way, the amount of rendered data transferring to the client 112 can change in quality or speed based off of the ability of the network communication interface 244 to send the information or based on the ability of the client 112 to accept and/or display the rendered scenes. The parameters can include latency, delay, a measure of bandwidth, frames currently stored in a queue, or other parameters measured or perceived by the client 112.

The delivery mechanism is adaptive, serving different components of the experience based on viewer behavior and type of interactive media. Thus, delivery may be completed by three different parts of the render engine 224: a foreground component 228, a background component 230, and a non-immersive component 232. The foreground component 228 may render the full model (but not the background of the scene) and may be used when the client 112 is in an augmented reality mode or when the background does not need to be served.

The foreground component 228 can generate the polygon mesh for the object being viewed. Then, the foreground component 228 can obtain both a depth map for the polygons from the depth map component 239 and colors for the polygons from the color component 236. The depth component 234 can provide a depth parameter (e.g., a position, in 3D space, for one or more points of the polygon) for each polygon in the type of rendering. The color component 236 can provide the color of each polygon. The foreground component 228 can generate the polygons from the model and provide this information to both the depth component 234 and the color component 236. The foreground component 228 can change the size and/or shape of the polygons, and thus, can change the resolution of the rendered model based on the information provided from the render engine 224.

The background component 230 can serve the background of the scene/model if a full virtual reality experience is being provided. With virtual reality, the whole scene around an object may also be served and delivered. Thus, the foreground component 228 can serve the model being looked at by the user and the background component 254 may server the background behind or around the foreground object. In some instances, the user may begin the interaction with an object or may interact or do other types of tasks with an object or scene that causes the foreground or background to be served simultaneously. For example, the user may force the object to interact with the background (e.g., bouncing a ball of a wall) that can cause both foreground and background to be integrated and served.

In at least some implementations, the non-immersive component 232 can provide delivery of a scene with which a client 112 cannot initially interact with. In these situations, the non-immersive component 232 can serve a scene and/or object as a video or other type of static content. The different components 224-232, of the render system, may then provide these image frames of final-render data to compressors 238 and 240. Compressor 238 may be a non-lossy temporal compressor. Compressor 238 can take the depth information, from the depth component 234, which might be a set of vectors for the different polygons, and compress those vectors to provide to the network interface 244a. Other information from the color component or immersive components may be provided to a lossy temporal compressor 240. This compressor 240 may compress the information about the background colors or non-immersive component and provide the compressed data to the network interface 244a.

Commands and flow control component 242b may provide flow data from the client 112 to the server 102; the flow control component 242a can provide commands from the server 102 to the client 102. The flow data can be information about how well the client 112 is receiving and processing the final-render data or model data and how well the client 112 is providing the interaction to the user. Any network issues or other issues, with the client 112 being unable to receive or process the rendered frames being sent by the server 112, can be reported to the flow control component 226 and/or the commands/flow component 242a. The flow information may be received by the flow component 242a to change or control the number of frames per second sent to the client 112. If a change is needed to help the client 112, the flow control component 226 and/or the commands/flow component 242a can modify the function of the render engine 224, can send fewer frames from the interface 244a, can change the level of rendering done by the client 112, or can make other adjustments. The client 112 can also have a command flow component 242b. This command flow component 242b can interact with the command flow component 242a to change the flow of information, frames, or sent commands.

Communication interface 244b can communicate compressed frames to the decompressors 246, 248. The decompressors may be components that decompress the data compressed by the compressors 238, 240. Thus, one decompressor 248 may decompress the compressed data from the temporal non-lossy compressor 238 using functions and algorithms that reverse the compression. The other decompressor 248 may decompress the temporal lossy compression from component 240. This decompressed information may be provided to render engines 250 through 258.

The render engines 250-258 may finish rendering the frame. For example, the rendering of a frame may be split between the server 102 and a client 112. A model maybe rendered at the server 102 and final rendering may happen at the client 112. Final rendering can include any portion of the rendering, for example, applying final color or lighting information to the model. In this way, the amount of data sent from the server 102 to client 112 is smaller and increases the frames per second. Further, leveraging the client's ability to render can also produce a more realistic rendering as the client 112 can have the final position or gaze information to change the model. The client 112 can render the foreground, with the foreground component 250, can render the depth components, with the depth component 252, and can render the background, with the background component 254.

Further, the server 102 can download models to the client 112. The client 112 may then complete all rendering. Render engine 258 can provide the final frames to the reprojection engine 260. Reprojection engine 260 can determine or project which frame is needed, at any given time, to provide to the display 114. Reprojection 260 may interleave or combine two or more frames together to provide more dynamic movement or interaction with the model.

The client 112 can also include a full control (a frames per second) component 264 that can determine whether the number of frames being provided to the client 112 for rendering or reprojection is too much or too little. The full control 264 can provide a queue or memory for the frames and determine the number of frames in the queue. If the queue has too many frames (e.g., 20 frames), the flow control component 264 can determine that the client or the network is not maintaining or providing the speed needed to render or use what is being sent from the server 102. This flow information can be relayed to the server 102 to change the amount of flow or frames per second being provided. The client 112 can also include a location or orientation from the DOF client 256 to determine the gaze of the user and any foveation to change the streaming of data to the client 112.

FIG. 2C shows a computing environment 270 that may function as the servers 102, user computers 112, or other systems provided and described herein, in accordance with embodiments of the present disclosure. The computing environment 270 includes one or more user computers, or computing devices, such as a client device 112a, a communication device 112b, and/or other devices, as represented by ellipses 272. The computing devices 112 may include general purpose personal computers (including, merely by way of example, personal computers, and/or laptop computers running various versions of Microsoft Corp.'s Windows® and/or Apple Corp.'s Macintosh® operating systems), mobile devices, AR/VR headsets, and/or workstation computers running any of a variety of commercially-available operating systems, etc. These computing devices 112 may also have any of a variety of applications, including for example, database client and/or server applications, and web browser applications. Alternatively, the computing devices 112 may be any other electronic device, such as a thin-client computer, Internet-enabled mobile telephone, and/or AR/VR headset, capable of communicating via a network 266 and/or displaying and navigating web pages, VR/AR scenes, or other types of electronic data or documents. Any spatially aware device able to measure DOF and/or eye-tracking will provide a fully immersive experience, while any desktop application will simulate a walkaround and walkthrough experience on a flat screen. Although the exemplary computing environment 270 is shown with two computing devices, any number of user computers or computing devices may be supported.

The computing environment 270 may also include one or more servers 102a, 102b. In this example, server 102a is shown as a web server and server 102b is shown as an application server. The web server 102a, which may be used to process requests for web pages or other electronic documents from computing devices 112. The web server 102a can be running an operating system including any of those discussed above, as well as any commercially available server operating systems. The web server 102a can also run a variety of server applications, including SIP (Session Initiation Protocol) servers, HTTP(s) servers, FTP servers, CGI servers, database servers, Java servers, network sockets and the like. In some instances, the web server 102a may publish operations available operations as one or more web services, for example, server 102a may function as the URL to access CMS databases.

The computing environment 270 may also include one or more file and/or/application servers 102b, which can, in addition to an operating system, include one or more applications accessible by a client running on one or more of the computing devices 112. In at least some configurations, the application server 102b can provide models to the clients 112 and/or receive requests for models or gaze information. The server(s) 102b may be one or more general purpose computers capable of executing programs or scripts in response to the computing devices 112. As one example, the server 102b may execute one or more web applications. The web application may be implemented as one or more scripts or programs written in any programming language, such as Java®, C, Ce, or C++, and/or any scripting language, such as Perl, Python, or TCL, as well as combinations of any programming/scripting languages. The application server(s) 102b may also include database servers, including without limitation those commercially available from Oracle®, Microsoft®, Sybase®, IBM ° and the like, which can process requests from database clients running on a computing device 112 or in server 102a.

The rendered scenes created by the server 102b may be forwarded to a computing device 112 via a web (file) server. Similarly, the web server may be able to receive web page requests, web services invocations, and/or input data from a computing device 112 (e.g., a user computer, etc.) and can forward the web page requests and/or input data to the web (application) server 102b. In further embodiments, the server 102b may function as a file server. Although for ease of description, FIG. 2C illustrates a separate web server 102a and file/application server 102b, those skilled in the art will recognize that the functions described with respect to servers 102b may be performed by a single server and/or a plurality of specialized servers, depending on implementation-specific needs and parameters. The computer systems 112, 102 may function as the system, devices, or components described in FIGS. 1-8.

The computing environment 270 may also include a database 268. The database 268 may reside in a variety of locations. By way of example, database 268 may reside on a storage medium local to (and/or resident in) one or more of the computers 112, 102. Alternatively, it may be remote from any or all the computers 112, 102, and in communication (e.g., via the network 266) with one or more of these. The database 268 may reside in a storage-area network (“SAN”) familiar to those skilled in the art. Similarly, any necessary files for performing the functions attributed to the computers 112, 102 may be stored locally on the respective computer and/or remotely, as appropriate. The database 268 may be a relational database, such as Oracle 20i®, that is adapted to store, update, and retrieve data in response to SQL-formatted commands. Database 268 may represent CMS databases and/or data stores 104.

FIG. 2D illustrates one embodiment of a computer system 274 upon which the servers 102, user computers 112, computing devices, or other systems or components described above may be deployed or executed. The computer system 274 is shown comprising hardware elements that may be electrically coupled via a bus 280. The hardware elements may include one or more central processing units (CPUs) 276; one or more input devices 278 (e.g., a mouse, a keyboard, etc.); and one or more output devices 292 (e.g., a display device, a printer, etc.).

Examples of the processors 276 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core® family of processors, the Intel® Xeon® family of processors, the Intel® Atom® family of processors, the Intel Itanium® family of processors, Intel® Core® i5-4670K and i7-4770K 22 nm Haswell, Intel® Core® i5-3570K 22 nm Ivy Bridge, the AMD® FX® family of processors, AMD® FX-4300, FX-6300, and FX-8350 32 nm Vishera, AMID® Kaveri processors, Texas Instruments® Jacinto C6000® automotive infotainment processors, Texas Instruments® OMAP® automotive-grade mobile processors, ARM® Cortex®-M processors, ARM®. Cortex-A and ARM926EJ-S® processors, other industry-equivalent processors, and may perform computational functions using any known or future-developed standard, instruction set, libraries, and/or architecture.

The computer system 274 may also include one or more storage devices 294. By way of example, storage device(s) 294 may be disk drives, optical storage devices, solid-state storage devices such as a random access memory (“RANI”) and/or a read-only memory (“ROM”), which can be programmable, flash-updateable and/or the like.

The computer system 274 may additionally include a computer-readable storage media/reader 281; a communications system 282 (e.g., a modem, a network card (wireless or wired), an infra-red communication device, etc.); and working memory 286, which may include RANI and ROM devices as described above. The computer system 274 may also include a processing acceleration unit 284, which can include a digital signal processor (DSP), a special-purpose processor, and/or the like.

The computer-readable storage media/reader 281 can further be connected to a computer-readable storage medium, together (and, optionally, in combination with storage device(s) 294) comprehensively representing remote, local, fixed, and/or removable storage devices plus storage media for temporarily and/or more permanently containing computer-readable information. The communications system 282 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 274 may also comprise software elements, shown as being currently located within a working memory 286, including an operating system 288 and/or other code 290. It should be appreciated that alternate embodiments of a computer system 274 may have numerous variations from that described above. For example, customized hardware might also be used and/or elements might be implemented in hardware, software (including portable software, such as applets), or both. Further, connection to other computing devices such as network input/output devices may be employed.

A final implementation of the system may be as shown in FIG. 2E. Servers 102a, 102b may provide, to a stich server 292, separate frames that render different portions of a model or scene. The stitch server 292a and a backup stitch server 292b function to stitch the two frames together into a single view for the client 112. Thus, separate parts of the model or separate models within the same view may be rendered by different servers 102. Then, the stitch server 292 may merge or amalgamate those two rendered frames or model views together into a single view, for a client 112. In this way, the amount of rendering capable by the servers 102 in the cloud can increase the amount of data provided with increased speed because separate threads for rendering can be performed at different servers 102.

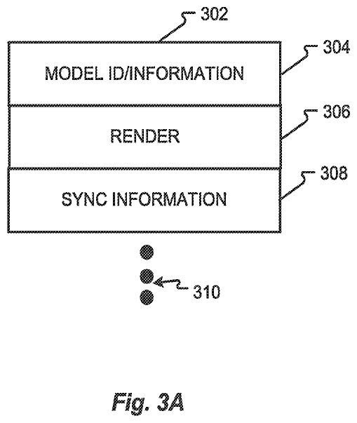

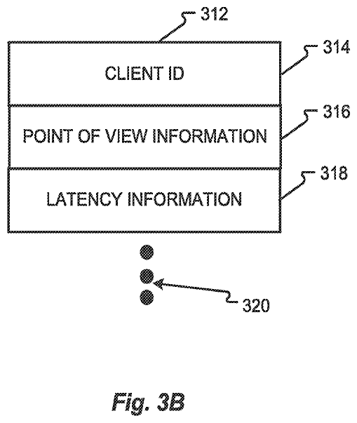

An example of a data structure 302 that may be stored, retrieved, communicated may be as shown in FIG. 3A. In at least some configurations, the data structure 302 includes information about a model requested by a client 112. The data structure 302 can include one or more of, but is not limited to, a model identifier (ID)/information 304, rendered information 306, and/or sync information 308. The data structure 302 could have more or fewer fields than that shown in FIG. 3 as represented by the ellipses 310.

The model identifier (ID)/information 304 can include an identifier for the model being requested or rendered. This model identifier (ID)/information 304 can be a numeric, alphanumeric, or other type of identifier. Other information or metadata about the model may also be provided in the model identifier (ID)/information 304. In some implementations, the server 102 can also download the model data to the client 112. In these configurations, the model identifier (ID)/information 304 can provide model data such that the client 112 can render scenes with the model data without the server 102.

The render information 306 may include information for and/or about the rendered frame. The rendered information 306 may include any information about polygons or points used to render the image, for example, shape of the polygons, the position, depth, color information, etc. The render information provides that information which can be used by the client 112 to display the rendered scene at the client 112.

Synchronous (sync) information 308 provides any information that synchronizes the frame and the temporal flow of frames to client 112. The sync information 308 also allows for the server 102 to sync the rendering of frames with the client's 112 current situation or orientation. Further, sync information 308 can include a time a model or frame request is received, the type of frame requested or returned within a flow of frames to the client 112, etc.

Another data structure 312 that may be sent from the client 112 to inform the server 102 of orientation changes may be as shown in FIG. 3B. The data structure 312 can include one or more of, but is not limited to, a client ID 314, point of view (POV) information 316, latency information 318, etc. The data structure 312 can include more or fewer data fields than that shown in FIG. 3B, as represented by ellipses 320.

The client ID 314 can include any type of identifier for that client 112. This identifier 314 can include a numeric ID, an alphanumeric ID, a globally unique ID (GUID), a network address, an Internet Protocol (IP) address, etc. This ID information 314 may be sent from the client 112 to the server 102 to allow the server 102 to identify which clients 112 are to receive frames.

POV information 316 can include any and/or all the parameters that are associated with the view of the user as provided by the DOF client 256. POV information 316 can include head orientation, pupil dilation and pupil focus for each eye separately, positioning information (e.g., GPS position), a coordinate position, movement information (e.g., head tilt, up or down motion, motion in space, etc.), orientation of the hands or other body parts, or any other type of information that allows for the proper rendering of model data.

Latency information 318 can include any type of information about how well the client 112 is receiving frames. This information 318 can include the number of frames currently in the queue at the client 112, the perceived network bandwidth at the client 112, other types of information. This latency information 318 may be provided by the flow control component 264 for the server 102.

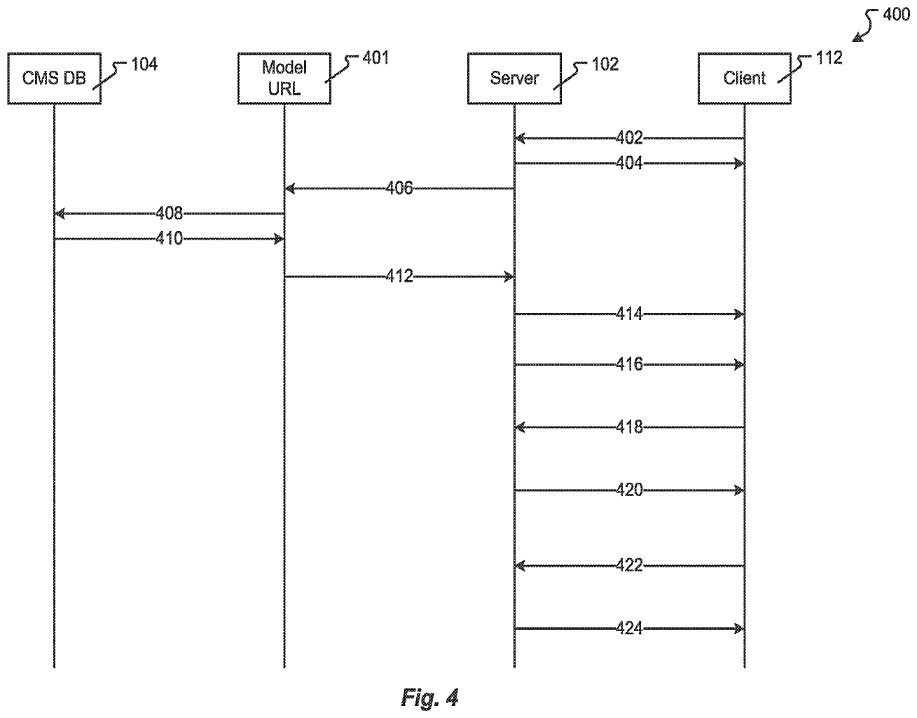

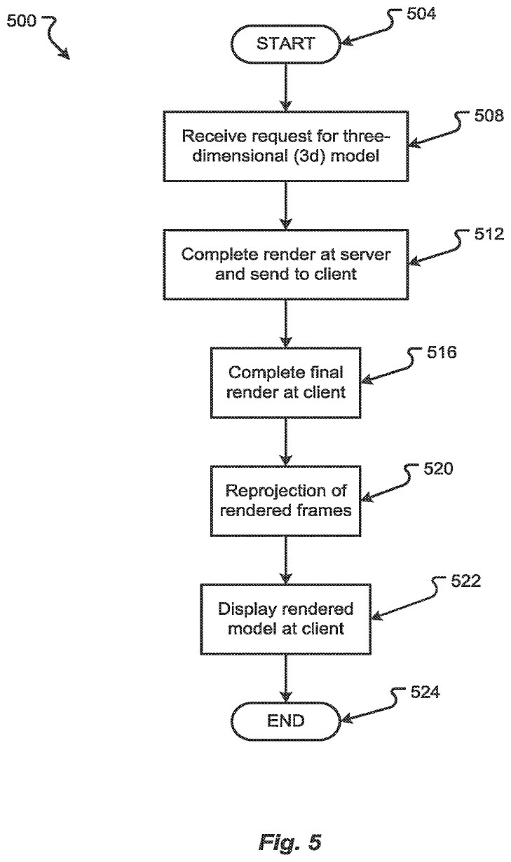

Implementations of a communication signaling process 400 maybe as shown in FIG. 4. The different components may communicate information amongst themselves. The components can include one or more of, but is not limited to, the content management system database 104, a model Uniform Resource Locator (URL) 401, a server 102, and a client 112. In implementations, the client 112 can send one or more model requests 402 to the server 102. The model request may be like data structure 302 provided to the server 102. This request 402 can include the model IDs or other model information to allow the server 102 to retrieve the model and render scenes for the client 112. The server 102 may send back and/or acknowledge the request message 402 with a response 404 to the client 112. The request acknowledgement message 404 can indicate that the request has been received. The message 404 can also include model data retrieved from the content cache 216. The cached model data can allow the server 102 to quickly provide rendered data to the client 112 without having to retrieve a model. Further, the server 102 can send rendered data of the cached model or send the cached model itself to allow local rendering by the client 112.

In some situations, server 102 may not have the content cached in the cache 216. In these situations, the server 102 may want or need to retrieve the model from a CMS 104. In configurations, the models may be accessed through a URL 401. The server 102 thus may send a request 406 to the URL 401. The request 406 can indicate the model ID 304 requested by the client 112. The model URL 401 may then access the appropriate CMS database 104. Thus, the model URL 401 can act as a single source for requesting models that may access one or more different CMS databases 104a-104d. The model URL 401 may then send the request message 408 to the CMS database 104 requesting the model CMS database 104 to access the content in the CMS database 104 and return the model information, in message 410 back to the model URL 401. The returned model information is then transferred, in message 412 back to the server 102.

Prioritizing access time, the server 102 may then begin, at least partially, rendering the model data and send the render data, as message(s) 414 to optimize for the shortest possible time to view. The rendering may include an initial video rather than a complete 3D rendering to ensure the client 112 quickly receives a rendered scene or model. After sending the initial video data in signal 416, the server 102 can render a more interactive 3D rendering of the model, which may be sent to the client 112. The subsequent renderings of the interactive 3D data can include all color and depth information and any other rendered data to make the model interactive. The system is designed to switch in real time between any/all delivery algorithms to continue optimizing quality of experience while providing near-instant model/scene loading and switching times.

Contemporaneously with sending the initial renderings 404, 414, the server 102 can send the model data in signal 416 to the client 112. Upon receiving the model data, client 112 may be capable of conducting some rendering. For example, the server 102 may only complete part of the rendering of the model (e.g., the polygon shape, color, and/or position), and the client 112 can complete any follow-on or further rendering of any other 3D model or scene data (e.g., the lighting and depth information). Thus, the rendering may be split between the server 102 and the client 112 at some time or for some time after the model data was or is provided to the client 112. Further, the client 112 can assume complete control of the rendering of the model after some period of time or after the totality of the model data is provided in signal 416. Thus, the amount of interaction or the level of detail in the rendering may increase as the client 112 continues to interact with a model. The system takes advantage of network communication valleys (where viewer movement and/or bandwidth fluctuations are minimal) to send more detailed rendering data from server 102 to client 112 and stay ahead of the viewing experience. For example, the initial rendering of the model may be a video; the rendering then proceeds to split between the server 102 a client 112. Finally, the client 112, if capable, conducts all rendering after downloading the model data. In this way, bandwidth usage declines as the user experience improves as time passes.

In implementations, the client 112 may periodically send signal 418, with information about the user's gaze. This signal 418 may be provided by the DOF client 256 and sent to the DOF client 220, at the server 102. This information 418 can include, as previously discussed, information about the head position, eye focus, etc., which is associated with the scene the client 112 is viewing. The server 102 may take this information and provide a spatially foveated stream 420 to the client 112. The foveated stream 420 changes the amount of data provided based on the information provided in signal 418. For example, only a portion of the scene is delivered in high resolution. The other portions of the scene in view of the user but not part of the focus may be delivered in lower resolution. The portion of the scene having high resolution may be associated with the focus of the client's gaze. If the portions of the model are not seen or there are portions that are hidden in the model, the server 102 does not deliver those portions for the client 112. Further, if the part of the model is outside the region of the gaze, the server 102 will not render that information and send that to the client.

Client 112 me update the gaze parameters and interaction with the model and send that information as signal 422. The server 102 then changes the rendered information, where some of the model information may be rendered by the server 102 and other model or scene data may be rendered by the client 112. Command(s) indicating what rendering is required of the client and/or the rendered information may be provided in signal 424. Further, the signal(s) 402, 418, and/or 422 sent from the client 112 can also include information about the client system including processing capabilities, memory, graphics processing capabilities, etc., information about latency or other environmental factors, or other information. With this information, the server 102 may determine whether to download the model 416 or what information or how the rendering may be split between the server 102 and the client 112.

FIG. 5 shows a method for providing interactive content to a user in accordance with aspects of the present disclosure. A general order for the steps of the method 500 is shown in FIG. 5. Generally, the method 500 starts with a start operation 504 and ends with an end operation 524. The method 500 can include more or fewer steps or can arrange the order of the steps differently than those shown in FIG. 5. The method 500 can be executed as a set of computer-executable instructions executed by a computer system(s) and encoded or stored on a computer readable medium. Further, the method 500 can be performed by gates or circuits associated with a processor, an application specific integrated circuit (ASIC), a field programmable gate array (FPGA), a system-on-chip (SOC), or other hardware device. Hereinafter, the method 500 shall be explained with reference to the systems, components, devices, modules, software, signals, data structures, interfaces, methods, etc. described in conjunction with FIGS. 1-4 and 8.

In implementations, a server 102 can receive a request for a 3D model, in stage 508. The user may be enjoying an augmented reality (AR) or virtual reality (VR) experience. The model data may be associated or displayed with the experience. The request may be automatic based on the user's interactions in the experience or may be a user-input request. The request may be a signal 402 sent from the client 112 to the server 102. In some implementations, the request is created when a user starts an AR, VR, or other application.

Render component 258 can provide a 3D information or model request, in stage 508. The request can include, for example, the model ID 304. The information request allows the server 102 to identify a model to render and/or provide for the client 112. The request you can also include information about the user's gaze. This gaze information may be provided by the DOF client 256. The gaze information allows the server 102 to determine what the user is viewing, the focal or fixation point of the user, determine the angle and other parameters of the user's view of the scene, and be able to determine foveation of the scene.

The server 102 may then complete a rendering, in stage 512. The model requested, the capabilities of the client 112, and the desired rending for the client 112 may be determined from their request. The information, for example, can include if the client 112 can conduct its own rendering. From that, the server 102 can determine the type or amount of rendering to do at the server 102. The server render components 224-236 can begin to render the scene as needed by the client 112.

A non-immersive component 232 can complete an initial rendering, which can be a video of the scene, in stage 512. This video may be presented to the client 112 at the beginning of the interaction between the server 102. If the client 112 continues to interact with the model requested, a more interactive rendering may be completed by the server render components 224-236. The first interactive model renderings may be completed fully at the server 102. The client 112 may at some point be capable to complete at least some rendering. At that point (e.g., after the model is downloaded), the client 112 may signal (e.g., in a DOF signal 418) that the client 112 can complete at least some of the rendering.

To perform split rendering between the server 102 and the client 112, the server 102 may deliver the foreground objects in full 3D with background objects in final-render video. The foreground component 228 may be render the foreground objects to send a better resolution visualization of the model for the focal point. Other parts of the image may have a lower resolution based on the foveation of the image. The background may be delivered by the background components 230 for a virtual reality experience, but may have a very low resolution. The rendered image may be compressed, by the compressors 238, 240, and sent to the client 112 through the two-way communications interface 244.

The client 112 can then complete a final render (reconstruction and reprojection) at the client, in stage 516. Render information may be used and adjusted by the render engine components 250-258. These components 250-258 can complete the final rendering. The amount of rendering completed at the server 102 and the amount completed at the client 112 can be adjustable based on the client capabilities or other settings. In some implementations, the client 112 or user may be able to send a signal to determine what rendering will be done at the client 122 and what will be done at the server 12. The final rendering can include final coloring, final texturing, final lighting of the scene, rendering the background or parts of the foveated scene. In some implementations, more rendering is happening at the client 112 as the client 112 receives model data.

The client 122 may then complete reprojection of the rendered images, in stage 520. The reprojection component 260 can adjust scene image provided by the renderer 258. The reprojection 260 allows for the combination of images or changing the image to match the user interaction. The images may then be displayed, in stage 522, at the client 112. Here, the display can provide frames and loop the reprojection to provide movement.

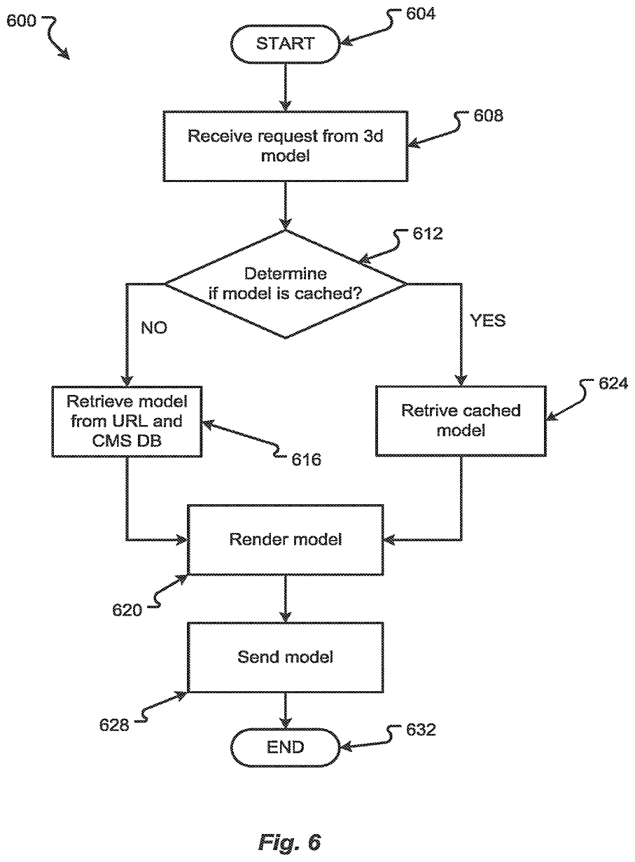

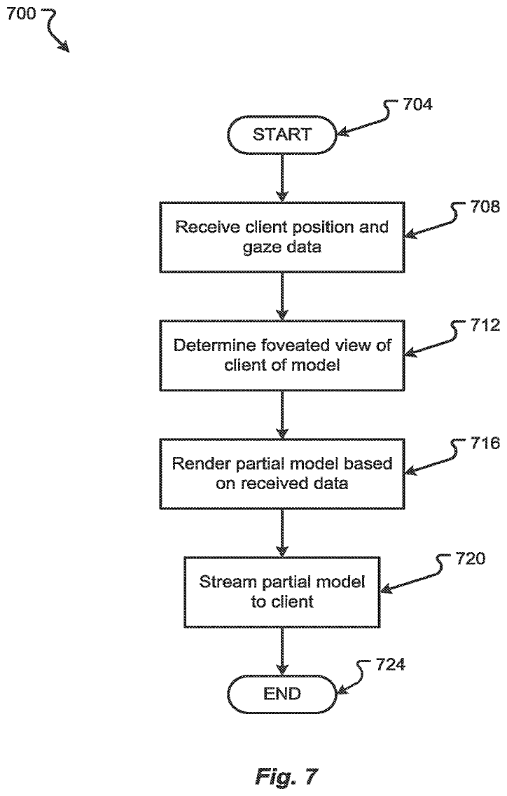

FIG. 6 shows a method for providing an extended reality experience in accordance with embodiments of the present disclosure. A general order for the steps of the method 600 is shown in FIG. 6. Generally, the method 600 starts with a start operation 604 and ends with an end operation 632. The method 600 can include more or fewer steps or can arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an application specific integrated circuit (ASIC), a field programmable gate array (FPGA), a system-on-chip (SOC), or other hardware device. Hereinafter, the method 600 shall be explained with reference to the systems, components, devices, modules, software, signals, data structures, interfaces, methods, etc. described in conjunction with FIGS. 1-5 and 8.

In implementations, a server 102 can receive a request for a 3D model, in stage 608. The user may be enjoying an augmented reality (AR) or virtual reality (VR) experience. The model data may be associated or displayed with the experience. The request may be automatic based on the user's interactions in the experience or may be a user-input request. The request may be a signal 402 sent from the client 112 to the server 102. In some implementations, the request is created when a user starts an AR, VR, or other application.

The server 102 can determine if the 3D model is cached, in stage 612. The server 102 can query a content cache 216 to determine if the 3D model is stored therein. In other implementations, the server 102 can request that the cloud content management system 214 determine if the 3D model is cached. The 3D model may be cached based on one or more factors or parameters. For example, if the content is retrieved by clients 112 on frequent basis, the content may be cached in a content cache 216. In other examples, if one or more clients 112 are interacting in similar AR or VR experiences in the same location, the content retrieved by a first client 112 may be cached for subsequent clients. If the content is determined to be stored in a cache 216, the method may proceed yes to stage 624. If the content is not cached, the method proceeds no to stage 616.

In stage 624, the server 102 may retrieve the 3D model from the content cache 216. In other implementations, the content management system 214 may retrieve the 3D model and provide that model to the server 102. In stage 616, the server 102 may send a request for the 3D model to a URL 401. The request 406 may be received by the model URL 401. The request 406 may include a model identifier 304. A server at the model URL 401 may then be able to send a request or retrieve the 3D model from the CMS database 104 by sending signal 408. The URL 401 may be in communication with several CMS databases 104. The model ID information may allow the server at the model URL 401 to determine which CMS database 104 to contact. The CMS database 104 can return the request of model back to the model URL 401 in signal 410. The model URL 401 may then send the retrieve 3D model to the server 102 and signal 412.

The server 102 may then render the retrieved or cached model, in stage 620. The rendering of the model may be the same or similar to that described in conjunction with FIG. 5. Thus, the components 224 through 236 can render different parts of the 3D model. The rendered frames associated with the model and/or the model itself may then be sent to the client 112, in stage 628. In implementations, the to a network interface 244 may send the model or frames to the client 112.

FIG. 7 shows a method for providing an extended reality experience in accordance with embodiments of the present disclosure. A general order for the steps of the method 700 is shown in FIG. 7. Generally, the method 700 starts with a start operation 704 and ends with an end operation 724. The method 700 can include more or fewer steps or can arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, an application specific integrated circuit (ASIC), a field programmable gate array (FPGA), a system-on-chip (SOC), or other hardware device. Hereinafter, the method 700 shall be explained with reference to the systems, components, devices, modules, software, signals, data structures, interfaces, methods, etc. described in conjunction with FIGS. 1-6 and 8.

The server 102 can receive user position and gaze information from the client 112, in stage 708. The client 112 can send, from the DOF client 256, information about what the user is viewing, in signals 418, 422. This point of view information 316 can include any type of information to allow the server 102 to determine how to render the model data. This information can include how the model is being viewed, at what angle, what is not being perceived by the user based on foveated viewing, what parts of the model are hidden or out of sight, and other information. This information is sent to the DOF client 220, at the server 102.

The DOF 220, at the server 102, can then determine the foveated view of the client 112 of the model, in stage 712. The foveated view includes determining what portions of the view should be delivered in low resolution, what parts of the model cannot be seen (front vs back, occlusions, beyond human field of view, behind, etc.), what other portions of the model or other models may not be viewed, whether there is an interior and/or exterior to the model and what can be seen, etc. These determinations allow for the server 102 to determine which of the model data should be delivered and in what resolution. Only the focus of the user need be delivered in high resolution with other parts of the model outside the focus receiving increasingly less resolution. Any parts of the model not being viewed, or any models not seen in the current frame of reference, are not delivered by the server 102. This information is passed to the render component 224 to determine how to render the model.

The render components 224-236 render the model data based on the received foveated view data, in stage 716. Thus, the render engine 224 may only deliver parts of the model rather than the entire model. The render component 224 can change the amount of resolution to use. In this way, parts of the data sent from the server 102 to the client are high resolution at the point of focus but lower resolution (which is less data because the polygons are larger) in the majority of the rendering, which reduces the bandwidth sent between the server 102 and the client 112. This information about the foveation may also be included with the packet(s) sent to the client 112 in the sync information 308. The partial model (high resolution in one portion of the model) can then be streamed to the client 112 to allow reduce bandwidth, in stage 720. The two-way communication component 244 can send the information, of the partially rendered model, to the client 112. The client 112 may conduct any other rendering required including possibly rendering the low-resolution parts or doing some other type of rendering at the client 112.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband/or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

Aspects of the present disclosure include a method comprising: receiving, at a server and from a client, a request for a three-dimensional (3D) model; partially rendering, at the server, the 3D model, wherein the client completes the rendering of the 3D model; and sending the partially rendered 3D model to the client.

Any of the one or more above aspects, wherein the 3D model is associated with a virtual reality or augmented reality experience.

Any of the one or more above aspects, wherein partial rendering comprises generating a point or polygon mesh for the model.

Any of the one or more above aspects, wherein the final rendering at the client comprises changing a color of two or more polygons to model lighting of a scene being viewed by a user.

Any of the one or more above aspects, wherein bandwidth required to send the partially rendered 3D model is less than bandwidth required for a fully rendered model.

Any of the one or more above aspects, wherein the client reprojects a frame associated with the rendered 3D model.

Any of the one or more above aspects, wherein the rendering conducted at the client is based on a capability of the client.

Any of the one or more above aspects, wherein the client displays the rendered 3D model.

Any of the one or more above aspects, further comprising: receiving gaze parameters from the client; determining foveation associated with the gaze parameters and the 3D model; and based on the foveation, stream more data to the client for a focal point of the foveation.

Any of the one or more above aspects, wherein a portion of the 3D model is not rendered based on the gaze parameters.

Aspects of the present disclosure include a system comprising: a memory; a processor in communication with the memory, wherein the processor executes instructions stored in the memory, which cause the processor to execute a method, the method comprising: receiving, at a server and from a client, a request for a three-dimensional (3D) model; partially rendering, at the server, the 3D model, wherein the client completes the rendering of the 3D model; and sending the partially rendered 3D model to the client.

Any of the one or more above aspects, the method further comprising: determining if the 3D model was previously cached; and retrieving the cached model.

Any of the one or more above aspects, wherein the partially rendering is conducted on the retrieved model.

Any of the one or more above aspects, the method further comprising: if the model is not cached; requesting the 3D model from a Uniform Resource Locator (URL); and receiving the model from the URL.

Any of the one or more above aspects, wherein a second server associated with the URL retrieves the request 3D model from a Content Management System.

Aspects of the present disclosure include a non-transitory computer readable medium having stored thereon instructions, which when executed by a processor cause the processor to execute a method, the method comprising: receiving, at a server and from a client, a request for a three-dimensional (3D) model; partially rendering, at the server, the 3D model, wherein the client completes the rendering of the 3D model; and sending the partially rendered 3D model to the client.

Any of the one or more above aspects, wherein the 3D model is retrieved from a Content Management System (CMS).

Any of the one or more above aspects, wherein the CMS is associated with one of: a cellular network, a Local Area Network (LAN), a cloud computing resource, or a device.

Any of the one or more above aspects, wherein the server also downloads the 3D model data to the client.

Any of the one or more above aspects, wherein the client completes the rendering after receiving at least a portion of the download 3D model data.

What is claimed is:

1. A method comprising:
receiving, at a server and from a client, a request for a three-dimensional (3D) model;
partially rendering, at the server, the 3D model, wherein the client completes rendering of the 3D model; and
sending the partially rendered 3D model to the client.

2. The method of claim 1, wherein the 3D model is associated with a virtual reality or augmented reality experience.

3. The method of claim 2, wherein partial rendering comprises generating a point or polygon mesh for the 3D model.

4. The method of claim 3, wherein final rendering at the client comprises changing a color of two or more points/polygons to model lighting of a scene being viewed by a user.

5. The method of claim 4, wherein bandwidth required to send the partially rendered 3D model is less than bandwidth required for a fully rendered model.

6. The method of claim 5, wherein the client reprojects a frame associated with the rendered 3D model.

7. The method of claim 6, wherein the rendering conducted at the client is based on a capability of the client.

8. The method of claim 7, wherein the client displays the rendered 3D model.

9. The method of claim 8, further comprising:
receiving gaze parameters from the client;
determining foveation associated with the gaze parameters and the 3D model; and
based on the foveation, streaming more data to the client for a focal point of the foveation.

10. The method of claim 9, wherein a portion of the 3D model is not rendered based on the gaze parameters.

11. A system comprising:
a memory;
a processor in communication with the memory, wherein the processor executes instructions stored in the memory, which cause the processor to execute a method, the method comprising:
receiving, at a server and from a client, a request for a three-dimensional (3D) model;
partially rendering, at the server, the 3D model, wherein the client completes rendering of the 3D model; and
sending the partially rendered 3D model to the client.

12. The system of claim 11, the method further comprising:
determining if the 3D model was previously cached; and
retrieving the cached model.

13. The system of claim 12, wherein the partially rendering is conducted on the retrieved model.

14. The system of claim 12, the method further comprising:
if the model is not cached, requesting the 3D model from a Uniform Resource Locator (URL); and
receiving the model from the URL.

15. The system of claim 14, wherein a second server associated with the URL retrieves the request 3D model from a Content Management System.

16. A non-transitory computer readable medium having stored thereon instructions, which when executed by a processor cause the processor to execute a method, the method comprising:
receiving, at a server and from a client, a request for a three-dimensional (3D) model;
partially rendering, at the server, the 3D model, wherein the client completes rendering of the 3D model; and
sending the partially rendered 3D model to the client.

17. The non-transitory computer readable medium of claim 16, wherein the 3D model is retrieved from a Content Management System (CMS).

18. The non-transitory computer readable medium of claim 17, wherein the CMS is associated with one of: a cellular network, a Local Area Network (LAN), a cloud computing resource, or a device.

19. The non-transitory computer readable medium of claim 16, wherein the server also downloads data associated with the 3D model to the client.

20. The non-transitory computer readable medium of claim 19, wherein the client completes the rendering after receiving at least a portion of the download 3D model data.
